(19) United States
(12) Patent Application Publication
(10) Pub. No.: US 2018/0189035 A1
(43) Pub. Date: Jul. 5, 2018

(54) APPLICATION DEVELOPMENT TOOL USING GRAPHIC OBJECTS TO BIND OBJECT SETS OF DIFFERENT DISTINCT DIVISIONS OF A DESIGN PATTERN

(71) Applicant: TechRev, LLC, Milpitas, CA (US)

(72) Inventors: VIJAY NARANG, PEMBROKE PINES, FL (US); SANJAY NARANG, PEMBROKE PINES, FL (US); RAMACHANDRAN RAMASUBBU, PEMBROKE PINES, FL (US)

(73) Assignee: TechRev, LLC

(21) Appl. No.: 15/393,503

(22) Filed: Dec. 29, 2016

(51) Int. Cl. G06F 9/44

(52) U.S. Cl. CPC G06F 8/35; G06F 8/34

(57) ABSTRACT

A code abstraction can be created within a software meta-development tool as a platform and programming language independent representation of a software application. The code abstraction can be comprised of action objects and data flow connectors. An action object can be a graphical placeholder representing software code that implements software behavior. Each action object can have an input and an output stream that are unconstrained by data type. A data flow connector can connect the output stream of one action object to the input stream of another sequentially-related action object. The data flow connector can graphically express a directional relationship and can define input data and transformation parameters. The data flow connector can implicitly represent the operations necessary to convert the input data in accordance with the transformation parameters. Authoring of the software code associated with the code abstraction by a user of the software meta-development tool can be unnecessary.

### BACKGROUND

The present invention relates to the field of software development and, more particularly, to an application development tool using graphic objects to bind object sets of different distinct divisions of a software design pattern. The software design pattern can be a Model-View-“whatever” (MV*) pattern, which includes a Model-View-Controller (MVC) pattern, a Model-View-ViewModel (MVVM) pattern, Model-View-Presenter (MVP) pattern, and the like. Stated differently, embodiments of the disclosure provide a platform and language independent means for expressing software functionality using graphical abstractions in accordance with details presented herein.

During the software development process, the functionality of a software application is defined and the supporting code written. The definitions take on a variety of forms (e.g., use cases, flowcharts, requirements specification, textual documents, etc.), depending on the particular development approach being employed.

A variety of tools, the most common being an integrated development environment (IDE), are available for writing the code for the software application. These tools typically automate repeated tasks and/or enforce restrictions. While these tools usually include a graphical means for designing a user interface, the code is textually represented. Further, these tools are written to support authoring code for a specific computing platform and/or using a specific programming language or family of languages, restricting code reusability and requiring more resources to accommodate multiple platforms and/or programming languages.

Even using these tools, creating software code is a tedious manual process that requires people who are well versed in the nuances of a specific platform and/or programming language. While there are tools that provide greater automation for code generation (i.e., CODESMITH Tools), these tools still represent the functionality of the software application as text. These text-based representations make it difficult to visualize how the various functions and data are related.

What is needed is a solution that allows the elements of software code to be graphically represented. Such a solution should create a representation that is independent of platform and programming language.

### BRIEF SUMMARY

One aspect of the present invention can include a software definition called a code abstraction. The code abstraction can be created within a software meta-development tool as a platform and programming language independent representation of a software application. The code abstraction can be comprised of action objects and data flow connectors. An action object can be a graphical placeholder representing software code that implements a behavior of the software application. Each action object can have an input stream and an output stream that are unconstrained by data type. A data flow connector can connect the output stream of one action object to the input stream of another sequentially-related action object. The data flow connector can graphically express a directional relationship between the connected action objects and can define input data and transformation parameters. A transformation parameter can specify a data format or a data type. The data flow connector can implicitly represent the data handling operations necessary to convert the input data in accordance with the transformation parameters. Authoring of the software code associated with the action objects and the data flow connectors by a user of the software meta-development tool can be unnecessary.

Another aspect of the present invention can include a software design method that begins by expressing each behavior of a software application as an action object on a canvas within a graphical user interface (GUI) of a software meta-development tool. The action object can be a graphical placeholder, having an input stream and an output stream, representing software code that implements a behavior of the software application. The input and output streams can be unconstrained by data type. The action object can be platform and programming language independent. The canvas can be a section of the software meta-development tool GUI capable of handling graphic elements. When required, the output stream of an action object can be connected to the input stream of another sequentially-related action object with a data flow connector on the canvas of the GUI. The data flow connector can graphically express a directional relationship between the action objects and can define input data and transformation parameters. A transformation parameter can specify a data format or a data type. The data flow connector can implicitly represent the data handling operations necessary to convert the input data in accordance with the transformation parameters. Authoring of the software code associated with the action objects and the data flow connectors by a user of the software meta-development tool can be unnecessary.

Yet another aspect of the present invention can include a computer program product that includes a computer readable storage medium having embedded computer usable program code. The computer usable program code can be configured to allow expression of each behavior of a software application as an action object on a canvas within a graphical user interface (GUI). The action object can be a graphical placeholder representing software code that implements a behavior of the software application. Each action object can have an input stream and an output stream that are unconstrained by data type. An action object can be platform and programming language independent. The computer usable program code can be configured to, when required, allow connection of the output stream of one action object to the input stream of another sequentially-related action object with a data flow connector on the canvas of the GUI. The data flow connector can graphically express a directional relationship between the action objects and can define input data and transformation parameters. A transformation parameter can specify a data format or a data type. The data flow connector can implicitly represent the data handling operations necessary to convert the input data in accordance with the transformation parameters. Authoring of the software code associated with the action objects and the data flow connectors by a user of the software meta-development tool can be unnecessary.

### BRIEF DESCRIPTION OF THE SEVERAL VIEWS OF THE DRAWINGS

FIG. 1 is a flowchart of a method describing the creation of a code abstraction in accordance with embodiments of the inventive arrangements disclosed herein. in accordance with embodiments of the inventive arrangements disclosed herein.

FIG. 2 is a block diagram illustrating a system implementing a software meta-development tool, the developer's efficiency workbench (DEW) tool in accordance with embodiments of the inventive arrangements disclosed herein.

FIG. 3 depicts example DEW tool GUIs showing a code abstraction in accordance with embodiments of the inventive arrangements disclosed herein.

### DETAILED DESCRIPTION

The present invention discloses a solution for graphically expressing software application functionality in a platform and programming language independent manner called a code abstraction. A software meta-development tool, specifically a developer's efficiency workbench (DEW) tool, can allow software behaviors to be represented as high-level, platform and programming language independent elements called action objects. An action object can be a graphical placeholder for the software code that implements the behavior like a “black box”. Action objects can have an input stream and an output stream that are unconstrained by data type. A data flow connector can be used to graphically express a directional relationship between action objects. The data flow connector can be used to connect the output stream of one action object to the input stream of another action object. Additionally, the data flow connector can define input data and/or transformation parameters. Therefore, the data flow connector can implicitly represent the data handling operations necessary to convert input data in accordance with the transformation parameters. The DEW tool can translate the action objects and data flow connectors into the necessary software code.

Embodiments of the disclosure, provide a graphical tool (which generates code; which permits code-based additions; which does not require developers to rely on code as the DEW is able to function as a pure GUI coding toolkit) for rapidly creating platform independent applications in accordance with a Model-View-Whatever (MV*) pattern. The MV* pattern includes, but is not limited to a Model-View-Controller (MVC) pattern, a Model-View-ViewModel (MVVM) pattern, and a Model-View-Presenter (MVP) pattern. Effectively, different portions of the code are created in different divisions from each other. One division represents the “model”, one represents the View, and another represents a “Controller”, “Presenter”, and/or “ViewModel”. That is, the DEW tool is compatible with different specific design patterns conforming to or consistent with the MV* paradigm. Different tabs or interactive sections of the DEW can be dedicated to each of the different divisions. In embodiments, the DEW can conform to the formalized rigor of the MV* patterns (MVC, MVVM, and/or MVP) can be adhered strictly. In other embodiments, a level of leniency or deviation from the more formalized patterns can be implemented for the DEW. As used herein, the DEW Model “tab” and related objects is consistent with “Model” division of the MV* pattern; the Presentation tab and related objects are consistent with the “View” division of the MV* pattern; and, the “Code Abstraction” tab and related objects are consistent with the “ViewModel” division or the “Controller” division of the MV* pattern.

Further, the divisions (of MV*) are bound to each other consistently using consistent bind objects, consistent GUI conventions (such as right-hand-side (RHS) to left-hand-side (LHS) columnar-matching techniques), and using common developer conventions. As a result, the DEW tool has a consistent and easy to learn “feel” from a developer perspective. Current research indicates that the DEW tool is able to reduce application coding and development time by approximately a quarter of the time it would otherwise take using more cumbersome tools. Further, the DEW utilizes abstraction principles, which permits an application developed in DEW to be customized and ported to various platforms (such as ANDROID, IOS, WINDOWS, WEB) with minimal changes to the application constructs themselves. This reduces maintained times and costs tremendously over conventional approaches, which often have disjoint development teams and code bases for different platform implementations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

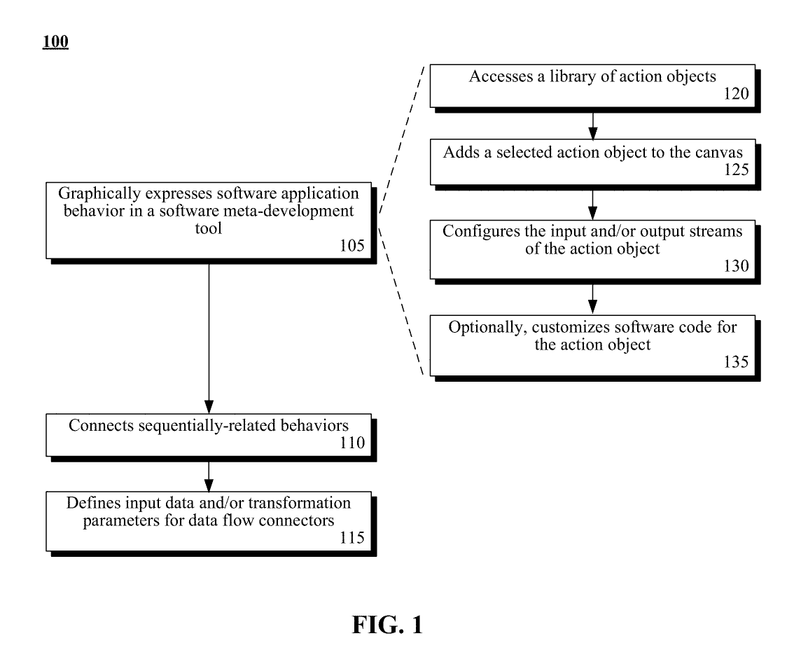

FIG. 1 is a flowchart of a method 100 describing the creation of a code abstraction in accordance with embodiments of the inventive arrangements disclosed herein. Method 100 can be performed by a software developer within the context of a software development process where the functionality of the software application being developed has been defined.

Method 100 can begin in step 105 where the software developer graphically expresses the behavior of a software application being developed in a software meta-development tool. A software meta-development tool can be a specialized software tool that supports a graphical and high-level approach to defining software functionality without requiring the developer to author the actual software code, as will be further discussed and illustrated.

In particular, step 105 can include substeps 120-135. A library of action objects can be accessed in step 120. An action object can be a graphical placeholder representing the software code that implements a specific behavior of the software application. The library can list the action objects available for use within the software meta-development tool.

In step 125, a selected action object can be added to the canvas. The canvas can be an area of the software meta-development tool's graphical user interface (GUI) where the use and/or manipulation of graphical elements is allowed. The selected object can be added using drag-and-drop or another comparable mechanism.

The input and/or output stream of the action object can be configured in step 130. Configuration of the input/output streams can include designating input/output parameters. To support platform/language independence, the input and output streams of the action objects can be unconstrained by data type. Optionally, in step 135, the software code for the action object can be customized. Customization of the code can involve code authoring, but it is not required.

After the software application behavior has been expressed, sequentially-related action objects can be connected in step 110. These connections can be represented using data flow connectors. A data flow connector can graphically express the directional relationship between the connected action objects and can define input data and transformation parameters. Thus, the input data and/or transformation parameters can be defined in step 115.

For example, a data flow connector can connect an action object that generates a value with a return action object to convey the generated value to the calling function. Further, the data flow connector can specify the format that the generated value should be returned.

It is important to note that the software application's functionality is being expressed at a high-level using terms that are platform and programming language independent. This approach can reduce the amount time spent by developers on tasks that are platform/language dependent, such as checking function names and parameter data types.

Since this representation of the software code is platform and programming language independent, it can also be used as the basis for generating the software application's code in accordance with different platforms and/or programming languages.

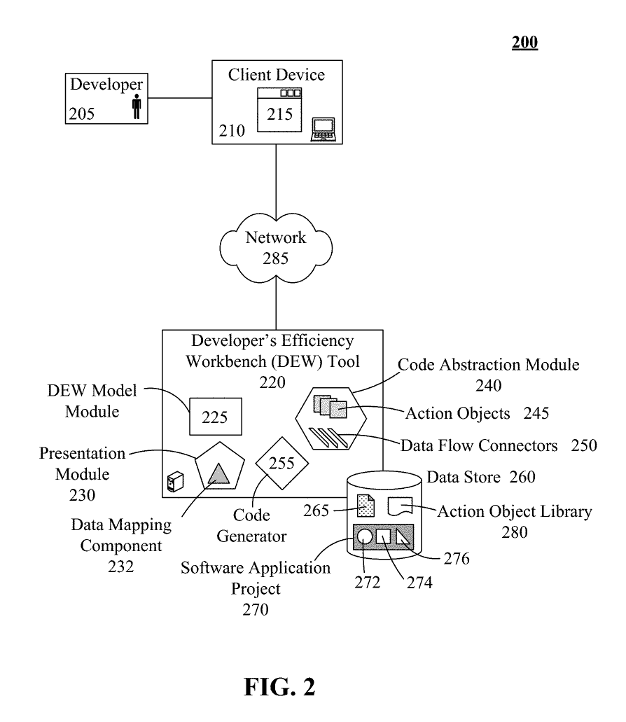

FIG. 2 is a block diagram illustrating a system 200 implementing a software meta-development tool, the developer's efficiency workbench (DEW) tool 220 in accordance with embodiments of the inventive arrangements disclosed herein. System 200 can perform the steps of method 100.

In system 200, a developer 205 can use a graphical user interface (GUI) 215 of the DEW tool 220 to develop a software application. The developer 205 can be a person having the requisite skills for software development using the DEW tool 220. The term “developer 205”, as used herein, can be interchangeable with the term “user”; a developer 205 can be a user having a specialized skill set.

The GUI 215 can represent the component of the DEW tool 220 that facilitates user interactions (e.g., data input, display data, etc.). The GUI 215 can run on a client device 210 used by the developer 205. The client device 210 can represent a variety of computing devices capable of supporting GUI 215 operations and communication with the DEW tool 220 over a network 285.

It should be noted that, although system 200 represents implementation of the DEW tool 220 using a client-server architecture, other system architectures and/or configurations can be used without departing from the spirit of the present invention.

The DEW tool 220 can be a specific implementation of a software meta-development tool. In general, the DEW tool 220 (and software meta-development tool) can represent the hardware and software necessary to implement a software development environment capable of generating software code from source documents that include a graphical representation of a software application's functionality as high-level, platform and programming language independent elements. The DEW tool 220 can support software development concepts known in the Art like the separation of software behavior from software presentation to allow parallel development processes.

Specifically, the DEW tool 220 can include a DEW model module 225, a presentation module 230, a code abstraction module 240, a code generator 255, a data store 260, and the like. The data store 260 can be used to store data 265, 270, and 280 that supports operation of the DEW tool 220. It should be noted that the components of the DEW tool 220 shown in system 200 can represent the core functionality and that additional components, such as a configuration management module, can be included to increase functionality.

The DEW model module 225, presentation module 230, and code abstraction module 240 can each be used by the developer 205 to create a corresponding source file—DEW model 272, presentation 274, and code abstraction 276—for a software application project 270. The software application project 270 can be a container for storing general data (e.g., name, intended platforms/languages, version, etc.) about and the source files 272, 274, and 276 that define the software application, as is common in the Art.

It should be noted that system 200 can present a simple representation (i.e., single source files) of a software application project 270 for the sake of discussion; more complex representations (i.e., dependencies, modular breakdown) can be utilized within the DEW tool 220.

The DEW model module 225 can represent the software component that supports generation of a DEW model 272. The DEW model 272 can be a collection (i.e., list) of data entities defined for use by the software application project 270. While a data entity represents data, the data of a data entity can come from a variety of sources, such as a database query, a Web service, or another DEW model 272 of the software application project 270, and can have various structures/types, such as a static value, a dynamic value, a dynamic event trigger, a data object, or a data collection. Therefore, the DEW model module 225 presents the developer 205 with the means to define the parameters for each data entity of the DEW model 272.

The presentation module 230 can generate one or more presentations 274 for the software application. A presentation 274 can define how and what data is displayed within a GUI of the software application. That is, the GUI can be designed using various elements or controls and the corresponding data entities in the DEW model 272 or action objects 245 of the code abstraction 276 can be linked to the GUI elements/controls. The presentation module 230 can utilize a data mapping component 232 to handle these relationships.

For example, a text box of the software application GUI for displaying an inventory quantity can be mapped to the corresponding data entity in the DEW model 272 that queries the inventory database for the corresponding value.

The presentation 274 can have a similar purpose as the view from a model-view-controller (MVC) or model-view-view model (MVVM) software architectural pattern. However, unlike an MVC or MVVM view, the presentation 274 can support data (DEW model 272) relationships; the MVC or MVVM view can be completely separated and unrelated to their corresponding data model.

The code abstraction module 240 can allow the developer 205 to create a code abstraction 276 for the software application. A code abstraction 276 can graphically represent the behavior or functionality of the software application using high-level, platform and programming language independent terms. As used herein, the term “high-level”, with respect to the code abstraction 276, can refer to terminology that represents a broader expression of a task and not a reference to a narrow expression of that task.

For example, the high-level term “find” can represent the task of finding something and that thing found can be influenced by particular parameters, whereas the term “find string” can only be used when finding a string; “find string” can implicitly embed the parameters within the term; the “find string” task can be performed by a “find” task that is provided with parameters that specify a string.

Conventional software development approaches can be focused on the narrow expressions of functionality, especially expressions that are related to a specific platform or programming language. The code abstraction 276 of the DEW tool 220 can eliminate the need for the developer 205 to know the specific name for a behavior, reducing the amount of time a developer 205 spends searching for this information.

The code abstraction 276 can be created using the action objects 245 and data flow connectors 250 provided by the code abstraction module 240. An action object 245 can be a graphical placeholder for the software code that implements the behavior of the software application like a “black box”. Each action object 245 can have an input stream and an output stream that are unconstrained by data type. That is, data type resolution for input/output variables can be performed during execution, not during development.

The action objects 245 that can be used within the code abstraction module 240 can be defined within an action object library 280 maintained by the DEW tool 220. The action object library 280 can be an inclusive list of action objects 245, however, a subset of the list can be presented to the developer 205 based upon the intended platforms and/or programming languages for the software application. That is, the developer 205 can be shown only those action objects 245 from the action object library 280 that are expressible in the intended programming languages (i.e., cannot use an action object 245 that is not supported by the programming language being used). Since action objects 245 are related to platform/programming language code, these relationships can be maintained in the action object library 280 for each action object 245.

Action objects 245 can be connected to each other using data flow connectors 250. A data flow connector 250 can graphically express a directional relationship between the action objects 245. Thus, a data flow connector 250 can be used to connect the output stream of one action object 245 to the input stream of another action object 245. It can be the responsibility of the developer 205 to ensure that validity of the sequential relationship between the connected action objects 245.

Additionally, the data flow connector 250 can define input data and/or transformation parameters. A transformation parameter can specify a data format or a data type. Thus, the data flow connector 250 can implicitly represent the data handling operations necessary to convert input data in accordance with the transformation parameters.

The lack of constraints on data types inherent in the code abstraction 276 can require the DEW tool 220 to utilize a means (i.e., software programming language or framework) that does not enforce strict data type binding like AngularJS.

The code generator 255 can represent the software algorithms that synthesize the DEW model 272, presentation 274, and code abstraction 276 into executable software code for a specified platform and/or programming language. In performing this task, the code generator 255 can additionally utilize a language library 265 and the action object library 280. The language library 265 can represent the syntax and/or specific code for the programming languages supported by the DEW tool 220. The programming languages can be packaged as modules that are added to the language library 265.

As used herein, presented data store 260 can be a physical or virtual storage space configured to store digital information. Data store 260 can be physically implemented within any type of hardware including, but not limited to, a magnetic disk, an optical disk, a semiconductor memory, a digitally encoded plastic memory, a holographic memory, or any other recording medium. Data store 260 can be a stand-alone storage unit as well as a storage unit formed from a plurality of physical devices. Additionally, information can be stored within data store 260 in a variety of manners. For example, information can be stored within a database structure or can be stored within one or more files of a file storage system, where each file may or may not be indexed for information searching purposes. Further, data store 260 can utilize one or more encryption mechanisms to protect stored information from unauthorized access.

Network 285 can include any hardware/software/and firmware necessary to convey data encoded within carrier waves. Data can be contained within analog or digital signals and conveyed though data or voice channels. Network 285 can include local components and data pathways necessary for communications to be exchanged among computing device components and between integrated device components and peripheral devices. Network 285 can also include network equipment, such as routers, data lines, hubs, and intermediary servers which together form a data network, such as the Internet. Network 285 can also include circuit-based communication components and mobile communication components, such as telephony switches, modems, cellular communication towers, and the like. Network 285 can include line based and/or wireless communication pathways.

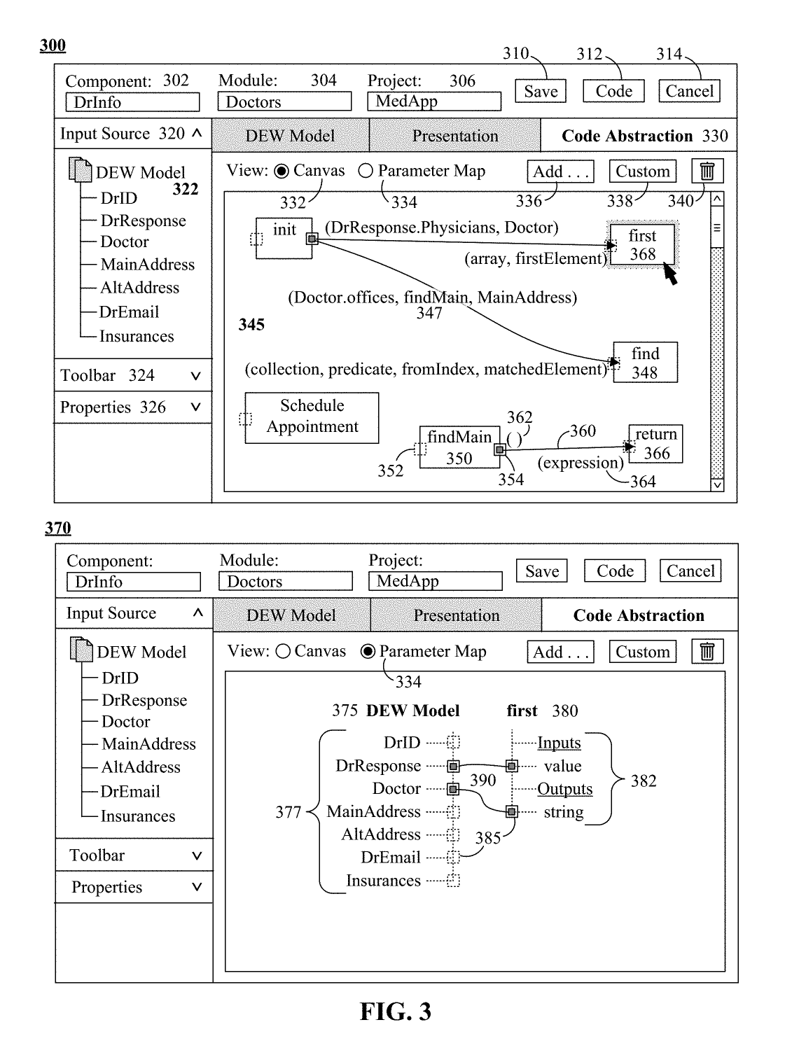

FIG. 3 depicts example DEW tool GUIs 300 and 370 showing a code abstraction in accordance with embodiments of the inventive arrangements disclosed herein. GUIs 300 and 360 can represent a specific embodiment of the GUI 215 of system 200.

GUIs 300 and 370 can include fields that present identifiers for the component 302, module 304, and project 306 that the code abstraction is associated to inform the developer. The component 302 and module 304 can be logical separations of the software application. The project 306 can represent the software application source files (i.e., software application project 270). In this example, the software application can be a medical application and the code abstraction is for a doctor information component of a doctor module.

GUIs 300 and 370 can also include general controls 310, 312, and 314. A save button 310 can trigger the current state of the code abstraction to be stored. The code button 312 can invoke the code generator and may be disabled until specific conditions have been met. Changes made to the code abstraction can be discarded via selection of the cancel button 314.

The left-hand side of the GUIs 300 and 370 can present the developer with expandable/collapsible access to information about the input source 320 being used, the available toolbar 324, and properties 326. The input source 320 can display the list of the data entities defined for the DEW model 322 for reference purposes.

The code abstraction tab 330 can be selected to provide data and controls specific to the creation of a code abstraction. The code abstraction tab 330 can include the means to select the presented view 332 and 334, add 336 elements (e.g., action objects and data flow connectors) to the canvas 332, customize 338 action object code, and delete 340 elements.

GUI 300 can present the canvas view 332 of the code abstraction. In the canvas view 332, the action objects and data flow connectors comprising the code abstraction can be graphically displayed on a canvas 332. The canvas 332 can be the area of the GUI 300 that supports the manipulation of graphical elements in addition to textual elements.

The add button 336 can be used to add action objects and data flow connectors to the canvas 345. The add button 336 can present a pop-up window listing action objects (from the action object library) and/or data flow connectors that can dragged and dropped onto the canvas 332, similar to other graphic software tools. Likewise, the custom button 338 can pop-up a window having a code editor where the developer can enter software code.

As shown in this example, action objects can be represented by named boxes and data flow connectors can be lines having an arrowhead. The action objects findMain 350 and return 366 can be used for discussion purposes.

The findMain 350 action object can be the box that represents code that finds the address of the main office of a doctor; a specific customized implementation of the find 348 action object. The findMain 350 action object can have an input 352 and output 354 stream represented by smaller boxes and adhering to a left-to-right flow (i.e., enter from the left and exit to the right). The input 352 of findMain 350 can be blank because the findMain 350 action object is called from data flow connector 347, which passes findMain 350 the data entity ‘Doctor.offices’.

The output 354 for findMain 350 can be connected to a return 366 action object with a data flow connector 360. Data flow connector 360 can indicate that the output 354 of findMain 350 is to be the input of the return 366 action object. Thus, data flows from findMain 350 to return 366, as indicated by the arrowhead.

Further, the data flow connector 360 can express that it accepts the output 354 of findMain 350, regardless of type or format, as indicated by parens 362 and provides return 366 with an expression 364 as input. The expression 364 can be a transformation parameter of the data flow connector 360, meaning that the output 354 from findMain 350 should be converted to an expression 364 before being input into the return 366 action object.

GUI 370 can present a parameter map view 334 of the first 368 action object selected in the canvas view 332. In GUI 370, the canvas 332 can be replaced with a parameter map of the action object called ‘first’ 368. The left side of the parameter map can list the data entities 377 of the DEW model 375 and the right side can list the elements 382 of the input and output streams of the ‘first’ 380 action object.

The data entities 377 of the DEW model 375 can be selectable as indicated by the boxes 385, unlike the DEW model 322 presented in the input source 320; the input/output stream elements 382 of the ‘first’ 380 action object can also be selectable. Selection of a data entity 377 can allow the developer to draw a line 390 to a stream element 382 and vice versa. This can allow the developer to graphically express relationships between action object input/output stream elements 382 and the data entities 377 of the DEW model 375.

Thus, the example parameter map shown in GUI 370 can read as the ‘first’ 380 action object receives a value 382 from the DrResponse data entity 377 as input and provides the Doctor data entity 377 with a string 382.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A software definition comprising:
a code abstraction created within a software meta-development tool as a platform and programming language independent representation of a software application, said code abstraction further comprising:
a plurality of action objects each having an input stream and an output stream, wherein an action object is a graphical placeholder representing software code that implements a behavior of the software application, wherein the input and output streams are unconstrained by data type; and
at least one data flow connector, wherein each data flow connector connects the output stream of a first action object to the input stream of a second action object, wherein the first and second action objects are sequentially-related, wherein the data flow connector graphically expresses a directional relationship between the connected action objects and defines input data and transformation parameters, wherein a transformation parameter specifies one of a data format and a data type, wherein the data flow connector implicitly represents data handling operations necessary to convert the input data in accordance with the transformation parameters;
wherein authoring of the software code associated with the plurality of action objects and the at least one data flow connector by a user of the software meta-development tool is unnecessary.

2. The software definition of claim 1, wherein the software meta-development tool generates the software code for the software application using the code abstraction.

3. The software definition of claim 1, wherein data represented by the code abstraction is presented within the software meta-development tool as a canvas view and a parameter map view, wherein the canvas view allows graphical manipulation of the plurality of action objects and the at least one data flow connector within a designated area of a graphical user interface (GUI) of the software meta-development tool, and the parameter map view allows linkages to be made between a list of user-defined data entities available for use by the software application on a left-hand side and a list of input and output variables for the respective input and output streams of a user-selected action object on a right-hand side, wherein data respective to linkages made in the parameter map view are propagated to corresponding representations in the canvas view.

4. The software definition of claim 3, wherein a linkage is graphically expressed as a line between an element in each list.

5. The software definition of claim 3, wherein the user-defined data entities are defined within a persistent data structure associated with the software application, wherein a user-defined data entity comprises one of a variable, a query string, an event trigger, an element of a GUI of the software application, and a data object.

6. The software definition of claim 1, wherein the action further comprises:
a set of user-inputted software code, wherein the user-inputted software code is associated with the action object, wherein the software meta-development tool uses the user-inputted software code to replace or augment its generated software code for the action object.

7. The software definition of claim 1, wherein the software meta-development tool is a developer efficiency workbench (DEW) tool.

8. A software design method comprising:
expressing each behavior of a software application as an action object on a canvas within a graphical user interface (GUI) of a software meta-development tool, wherein the action object is a graphical placeholder, having an input stream and an output stream, representing software code that implements a behavior of the software application, wherein the input and output streams are unconstrained by data type, wherein the action object is platform and programming language independent, wherein the canvas is a section of the software meta-development tool GUI capable of handling graphic elements; and
when required, connecting the output stream of a first action object to the input stream of a second action object with a data flow connector on the canvas of the GUI, wherein the first and second action objects are sequentially-related, wherein the data flow connector graphically expresses a directional relationship between the first and second action objects and defines input data and transformation parameters, wherein a transformation parameter specifies one of a data format and a data type, wherein the data flow connector implicitly represents data handling operations necessary to convert the input data in accordance with the transformation parameters;
wherein authoring of the software code associated with action objects and data flow connectors by a user of the software meta-development tool is unnecessary.

9. The method of claim 8, wherein expressing each behavior further comprises:
selecting the action object from an action object library maintained by the software meta-development tool; and
placing the selected action object on the canvas via a drag-and-drop mechanism.

10. The method of claim 8, wherein, when deemed necessary by a user of the software meta-development tool, expressing behavior further comprises:
selecting an action object on the canvas;
invoking a means for inputting software code;
inputting software code into said means; and
storing the inputted software code, wherein the stored software code is associated with the selected action object, wherein the software meta-development tool uses the stored software code to replace or augment its generated software code for the action object.

11. The method of claim 8, further comprising:
accessing a parameter map of the action object via a mechanism of the software meta-development tool GUI, wherein said parameter map presents a list of user-defined data entities available for use by the software application on a left-hand side and a list of input and output variables for the respective input and output streams of the action object on a right-hand side, wherein the user-defined data entities are defined within a persistent data structure associated with the software application; and
linking a user-defined data entity to one of an input variable and an output variable of the action object, wherein said linkage is graphically expressed as a line between both lists, wherein data respective to linkages made in the parameter map are propagated to corresponding representations on the canvas.

12. The method of claim 11, wherein the user-defined data entity comprises one of a variable, a query string, an event trigger, an element of a GUI of the software application, and a data object.

13. The method of claim 8, wherein the software meta-development tool is a developer efficiency workbench (DEW) tool.

14. The method of claim 8, wherein performance of said steps creates a code abstraction that is a platform and programming language independent, graphical representation of the software application's code.

15. A computer program product comprising a computer readable storage medium having computer usable program code embodied therewith, the computer usable program code comprising:
computer usable program code configured to allow expression of each behavior of a software application as an action object on a canvas within a graphical user interface (GUI), wherein the action object is a graphical placeholder, having an input stream and an output stream, representing software code that implements a behavior of the software application, wherein the input and output streams are unconstrained by data type, wherein the action object is platform and programming language independent; and
computer usable program code configured to, when required, allow connection of the output stream of a first action object to the input stream of a second action object with a data flow connector on the canvas of the GUI, wherein the first and second action objects are sequentially-related, wherein the data flow connector graphically expresses a directional relationship between the first and second action objects and defines input data and transformation parameters, wherein a transformation parameter specifies one of a data format and a data type, wherein the data flow connector implicitly represents data handling operations necessary to convert the input data in accordance with the transformation parameters;
wherein authoring of the software code associated with action objects and data flow connectors by a user is unnecessary.

16. The computer program product of claim 15, wherein performance of said steps by the computer program product creates a code abstraction that is a platform and programming language independent, graphical representation of the software application's code.

17. The computer program product of claim 15, wherein expressing each behavior further comprises:
computer usable program code configured to allow selection of the action object from an action object library; and
computer usable program code configured to allow placement of the selected action object on the canvas via a drag-and-drop mechanism.

18. The computer program product of claim 15, wherein, when deemed necessary by a user, expressing behavior further comprises:
computer usable program code configured to allow selection of an action object on the canvas;
computer usable program code configured to allow invocation of a means for inputting software code;
computer usable program code configured to allow inputting of software code into said means; and
computer usable program code configured to allow storing of the inputted software code, wherein the stored software code is associated with the selected action object, wherein the stored software code is subsequently used to replace or augment dynamically-generated software code for the action object.

19. The computer program product of claim 18, further comprising:
computer usable program code configured to allow access to a parameter map of the action object, wherein said parameter map presents a list of user-defined data entities available for use by the software application on a left-hand side and a list of input and output variables for the respective input and output streams of the action object on a right-hand side, wherein the user-defined data entities are defined within a persistent data structure associated with the software application; and
computer usable program code configured to allow linking of a user-defined data entity to one of an input variable and an output variable of the action object, wherein said linkage is graphically expressed as a line between both lists, wherein data respective to linkages made in the parameter map are propagated to corresponding representations on the canvas.

20. The computer program product of claim 19, wherein the user-defined data entity comprises one of a variable, a query string, an event trigger, an element of a GUI of the software application, and a data object.
